(19) United States
(12) Patent Application Publication
(10) Pub. No.: US 2013/0186655 A1
(43) Pub. Date: Jul. 25, 2013

(54) FIRE EXTINGUISHER AND DISCHARGE NOZZLE ASSEMBLY

(71) Applicant: Ronald C. Mauney, Snow Camp, NC (US)

(72) Inventor: Ronald C. Mauney, Snow Camp, NC (US)

(21) Appl. No.: 13/806,280

(22) PCT Filed: Jun. 25, 2010
(86) PCT No.: PCT/US10/39977

§ 371 Date: Mar. 6, 2013

(51) Int. Cl. A62C 13/76

(52) U.S. Cl. CPC A62C 13/76
USPC 169/74

(57) ABSTRACT

A portable handheld dry chemical fire extinguisher is provided that includes a discharge nozzle assembly that is uniquely suited for fighting cooking oil fires. The discharge nozzle assembly discharges a relatively low velocity, high volume flow of dry chemical fire extinguishing agent that gently curves downwardly over a relatively short reach to fall into the fire, such as a cooking oil fire in a cooking vessel on a range top, without splashing.

### FIELD OF THE INVENTION

This invention relates generally to fire extinguishers and, more particularly, to a handheld fire extinguisher particularly suited for fighting flammable liquid fires at relatively close range and discharge nozzle assembly for dispensing a dry chemical fire extinguishing agent.

### BACKGROUND OF THE INVENTION

Historically, handheld fire extinguishers for fighting flammable liquid fires, such as kitchen cooking fat or oil fires, have used a dry chemical fire extinguishing agent such as a metal alkali salt, typically sodium bicarbonate. The basic principle behind dry chemicals in extinguishing cooking fires is to combine the fatty esters in the liquid, such as cooking fat or oil, with a metal alkali salt. Dry chemical fire extinguishers have been effective against a variety of cooking fat and oil fires, but vary in efficiency. For example, such dry chemical agents achieve faster results fighting cooking fires involving animal fats than when used in fighting fires involving lighter vegetable-based cooking oils, as cooking oil is extremely hot at ignition, typically about 370 degrees Celsius (about 700 degrees Fahrenheit). Extinguishment and suppression of a cooking oil fire includes not only extinguishing the flames as quickly as possible, but also preventing reignition of the very hot cooking oil. The discharge nozzles associated with conventional fire extinguishers are typically designed to discharge a relatively high velocity stream having a relatively long reach. Thus, when using conventional handheld portable fire extinguishers to extinguish a kitchen stove top fire, it is typically recommended that the operator stand a distance of about 10 feet (about 3 meters) away from the fire and obtain an angle of entry of the stream of fire extinguishing agent onto the fire of about forty-five degrees, thus, the suppression agent is delivered over the fire at the same time avoiding the risk that oil would splash out of the skillet.

### SUMMARY OF THE INVENTION

In an aspect, a portable dry chemical fire extinguisher is provided for efficiently suppressing and extinguishing flammable liquid fires, such as residential cooking oil fires at a relatively close range compared to conventional extinguishers. The fire extinguisher includes a discharge nozzle assembly for discharging a relatively low velocity, high volume flow of dry chemical fire extinguishing agent for efficiently suppressing and extinguishing flammable liquid fires, such as animal fat and cooking oil fires, at a relatively close range. The hand-held fire extinguisher includes a vessel containing a dry powder fire extinguishing agent and a discharge nozzle assembly. The discharge nozzle assembly includes a discharge nozzle and a horn. The horn circumscribes a distal end of the discharge nozzle and defines a discharge chamber having an open distal end. The discharge nozzle has a discharge passage in its distal end including a dispersion slot opening into the discharge chamber of the horn. The dispersion slot is adapted to establish a flow of fire extinguishing agent in a fan-like distribution to impact an interior surface of the horn. In an embodiment, the discharge nozzle has a flow passage having a longitudinally elongated inlet passage in communication with the vessel for receiving a flow of dry powder fire extinguishing agent released from the vessel and a pair of discharge passages comprising dispersion slots in the distal end of the discharge nozzle. The dispersion slots are in flow communication with and extend transversely to the inlet section of the discharge passage and open into the discharge chamber of the horn.

In an aspect, a discharge nozzle is provided. The discharge nozzle includes an elongated body having a head and a shaft extending from the head along a longitudinal axis. The body further includes a flow passage having an elongated inlet passage extending along the longitudinal axis and a pair of dispersion slots in the head extending transversely to the longitudinal axis of the flow passage. Each dispersion slot of the pair of dispersion slots is in flow communication with the inlet passage and constitutes a discharge passage. A first outlet opens from the inlet passage into a first of the dispersions slots and a second outlet opens from the inlet passage into a second of the dispersion slots. Each of the dispersion slots defines a fan-like discharge passage. Each of the dispersion slots extends perpendicularly relative to the longitudinal axis inlet passage.

### BRIEF DESCRIPTION OF THE DRAWINGS

For a further understanding of the disclosure, reference will be made to the following detailed description which is to be read in connection with the accompanying drawing, where:

FIG. 1 is an elevation view of a portable fire extinguisher;

FIG. 2 a side elevation view, partly in section, of the upper portion of the portable fire extinguisher of FIG. 1 showing an exemplary embodiment of a discharge nozzle assembly in accordance with the disclosure herein;

FIG. 3 is a sectioned side elevation view of the discharge nozzle assembly of FIG. 2;

FIG. 4 is a perspective view of the horn of the discharge nozzle assembly of FIG. 3;

FIG. 5 is perspective view of the discharge nozzle of the discharge assembly of FIG. 3;

FIG. 6 is a side elevation view of the discharge nozzle of FIG. 5;

FIG. 7 is a sectioned side elevation view of the discharge nozzle of FIG. 6;

FIG. 8 is a sectioned plan view taken along line 8-8 of FIG. 7;

FIG. 9 is a sectioned elevation view taken along line 9-9 of FIG. 6; and

FIG. 10 is an illustration showing the discharge of fire extinguishing agent from the fire extinguisher disclosed herein in fighting a cooking oil fire in a skillet on a range top.

### DETAILED DESCRIPTION OF THE INVENTION

Referring initially to FIGS. 1 and 2 of the drawing, there is depicted an exemplary embodiment of a portable handheld fire extinguisher 20 including a vessel 22 containing a dry chemical fire extinguishing agent under pressure, a discharge actuator assembly 24 capping the outlet throat of the vessel 22 and including a safety lock pin 26 and a trigger mechanism, for example handle 28, and a discharge nozzle assembly 30. The discharge nozzle assembly 30 includes a discharge nozzle 32 and a discharge horn 34 extending coaxially about the discharge nozzle 32.

With the exception of the discharge nozzle assembly 30, the design and construction of the fire extinguisher 20 is not germane to the invention and may be of any conventional design and construction. The vessel 22 may be a pressure vessel of conventional design and made of steel, stainless steel, aluminum or other conventional materials. The discharge actuator assembly 24 may also be of any conventional design and may include any combination of valve and actuator assembly and trigger mechanism operable to release a flow of fire extinguishment from the vessel 22 into the discharge nozzle 32 upon manual activation of the triggering mechanism.

As depicted and described herein, the fire extinguisher 20 is a portable, hand-held, dry chemical fire extinguisher particularly suited for use in extinguishing and suppressing flammable liquid fires, such as, but not limited to, a cooking oil fire in a skillet, pot, griddle or other cookware on a range top. The fire extinguishing agent contained in the vessel 20 is in the form of a dry powder in a pressurized atmosphere of a propellant gas. The dry powder fire extinguishing agent may be an alkali metal salt, such as for example, but not limited to, sodium bicarbonate or potassium bicarbonate. These alkali metal bicarbonates disassociate to release the alkali metal ion and also carbon dioxide gas upon exposure to the flaming cooking oil. The alkali metal ions combine with the fatty acids in the hot oil to form a soap film over the surface of the cooking oil to forestall auto-reignition. The released carbon dioxide gases dilute the oxygen concentration in the immediate vicinity of the flame. The propellant gas may be dry air, or a chemically non-reactive gas, for example nitrogen or an inert gas, pressurized to a pressure of about 100 pounds per inch (psi).

When it is necessary to use the fire extinguisher to suppress a fire, the user pulls the safety lock pin 26 out of the discharge actuator assembly 24 to release the handle 28 and then squeezes the handle to drive the valve stem 36 downwardly against the pressure within the vessel 22, thereby moving the valve 38 away from a seat on the discharge actuator assembly 24 and opening a flow path 40 through the discharge actuator assembly 24. Upon opening of the flow path 40, flow communication is established between the interior of the vessel 22 and the discharge nozzle 32 whereby the dry powder chemical fire extinguishing agent is propelled from the interior of the vessel 22 through the flow passage 40 within the discharge actuator assembly 24 into and through the discharge nozzle 32 to discharge through the open end of the horn 34.

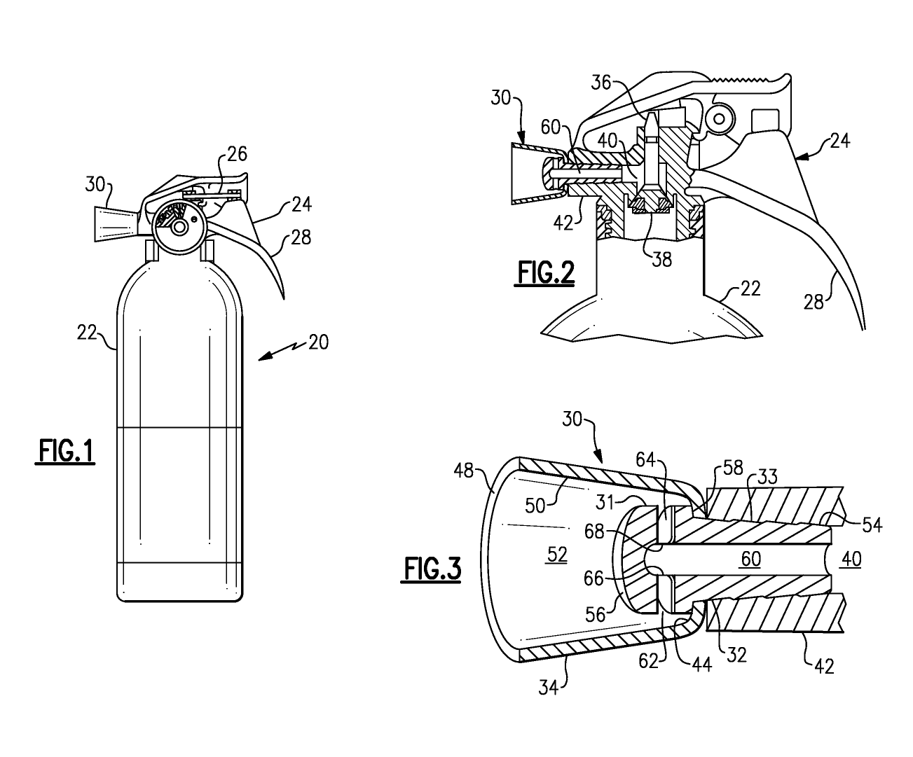

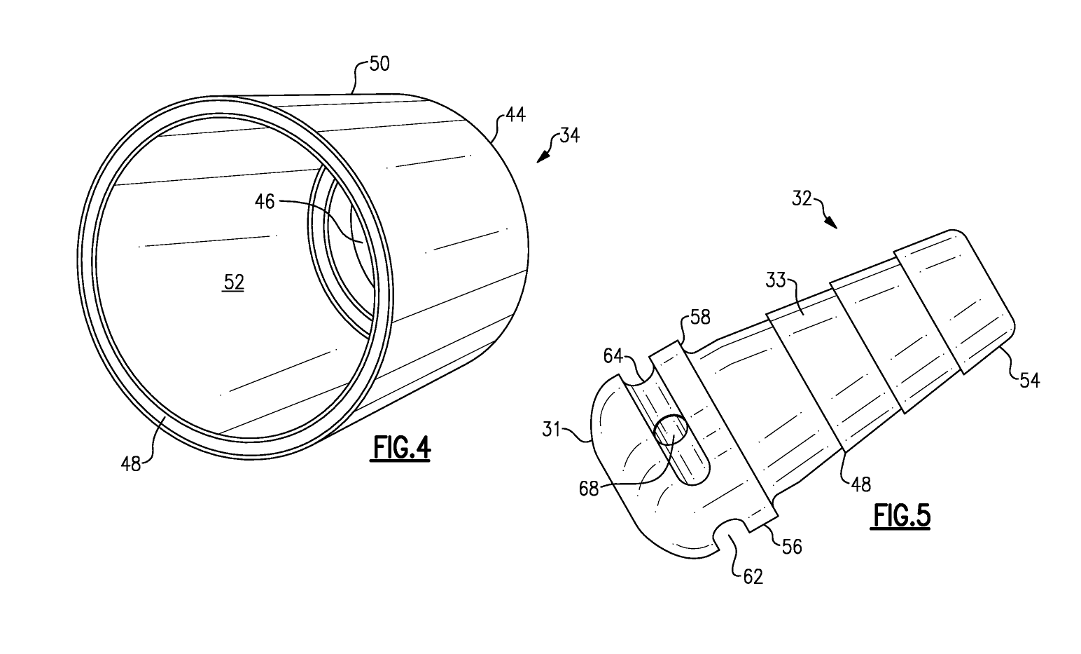

Referring now to FIGS. 3-5, in particular, the discharge nozzle assembly 30 includes the discharge nozzle 32 and horn 34. The horn 34 has a proximal end having a base 44 having a central opening 46, an open distal end 48, and a wall 50 extending circumferentially and longitudinally between an outer circumference of the base 44 and the open distal end 48. In the depicted embodiment, the wall 50 comprises a generally conical wall that diverges outwardly from its proximal end to its distal end at an angle with respect to the longitudinal axis in the range of 6 to 8 degrees (i.e. an included angle in the range of 12 to 16 degrees). The horn 34 defines a discharge chamber 52 having a discharge exit defined by the open distal end 48.

The discharge nozzle 32 has an elongated body having a head 31 and a shaft 33. The shaft 33 extends from a proximal end 54 of the discharge nozzle 32 to the head 31 at a distal end 56 of the discharge nozzle 32. In assembly with the horn 34, the shaft 31 of the discharge nozzle 32 passes through the central opening 46 of the horn 34 until the base 44 of the horn 34 abuts a shoulder 58 on the head 31 of the discharge nozzle 32. To mount the discharge nozzle assembly 30 to fire extinguisher 20, the shaft 31 of the discharge nozzle 32 is received within the outlet end 42 in a force fit or snap fit relationship and secured therein by ridges 48 in the exterior surface of the proximal end 54 of the discharge nozzle 32. The base 44 of the horn 34 is held between the shoulder 58 on the head 31 of the discharge nozzle 32 and the end face of the outlet end 42 of the discharge actuator assembly 24. The head 31 of the discharge nozzle 32 is disposed within the discharge chamber 52 of the horn 34.

Referring now to FIGS. 5-9, in particular, the discharge nozzle 32 has a flow passage including a longitudinally elongated inlet passage 60 and a pair of dispersion slots 62, 64 in the discharge nozzle head 32 in the distal end 56 of the discharge nozzle 30. The dispersion slots 62, 64, which extend transversely to the inlet passage 60 to form oppositely directed discharge passages, open into the discharge chamber 52 defined by the horn 34 on opposite sides of the discharge nozzle 30. In this manner, the discharge forces of the oppositely directed discharge streams are balanced one against the other. The inlet passage 60 has a first outlet 66 that opens into the dispersion slot 62 and a second outlet 68 that opens into the second dispersion slot 64. Thus, the dispersion slots 62, 64 are in flow communication with the inlet passage 60 through the first and second outlets 66, 68, respectively. In an embodiment, the width of each of the dispersion slots 62, 64 may be slightly less, for example by about 10%, than the diameter of the respective outlets 66, 68. The inlet passage 60 has an inlet opening at the proximal end 54 of the discharge nozzle 32. When the discharge nozzle assembly is mounted to the fire extinguisher 20, the inlet passage 60 is in communication at the proximal end 44 of the discharge nozzle 32 with the flow path 40 through the discharge actuator assembly 24 for receiving a flow of dry powder fire extinguishing agent released from the vessel 22 upon actuation of the fire extinguisher.

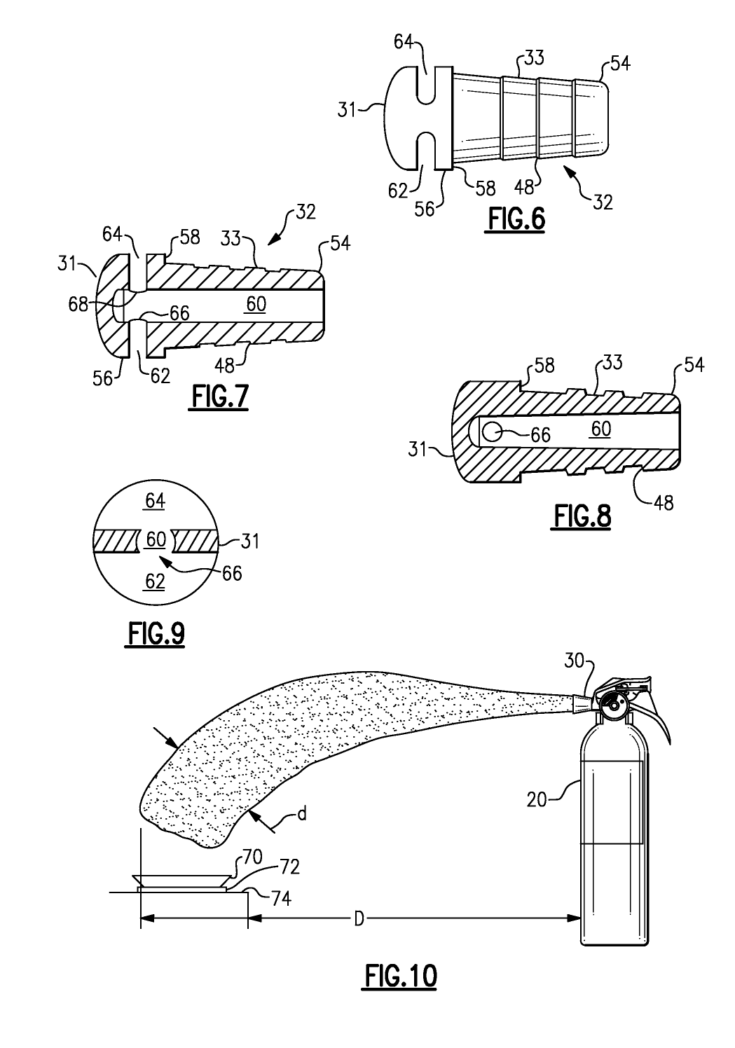

As best seen in FIGS. 7 and 9, each of the dispersion slots 62, 64 defines a fan-like discharge passage having a circumferentially extending outlet opening through which the dry powder fire extinguishing agent discharges into the proximal end of the discharge chamber 52. In passing through the dispersion slots 62, 64, the dry powder fire extinguishing agent will spread outwardly to discharge into the chamber 52 in a circumferentially extending continuous arc fan-like distribution. With the first and second dispersion slots 62, 64 disposed on opposite sides of head 31 of the discharge nozzle 32 and extending transversely to the longitudinal axis of the flow passage, a radially outwardly directed discharge of fire extinguishing agent is achieved that extends circumferentially in two diametrically opposed arcs. With the transversely extending dispersion slots directing the fire extinguishing agent radially outward into the discharge chamber 52, the axial velocity component of the discharged flow is essentially eliminated, thereby reducing the throw or reach of the flow of fire extinguishing agent subsequently discharging from the horn.

The fire extinguishing agent discharging through each of the dispersion slots 62, 64 is discharged into the proximal end region of the discharge chamber 52 with sufficient momentum to impact upon the inside surface of the wall 50 of the horn 34 in a substantially continuous fan-like distribution before proceeding downstream to exit the discharge chamber 52 through the open distal end 48 of the horn 34. The circumferential spreading of the fire extinguishing agent passing into the discharge chamber through each of the dispersion slots 62, 64 as a fan-like discharge, and the turbulence generated in the flow as a result of the impact with the inside surface of the wall 50 of the horn 34 ensure that a relatively low velocity, cloud of fire extinguishing agent exits through the open distal end 48 of the horn 34 encompassing a substantially complete 360 degree arc with relative uniformity in the concentration of fire extinguishing agent, as opposed to a relatively high velocity, relatively concentrated stream, discharging from the discharge nozzle assembly. The external surface of the portion of the head 31 downstream of the dispersion slots 62, 64 may be rounded to provide an aerodynamic surface that further enhances formation of the relatively uniform cloud of fire extinguishing agent.

Referring now to the illustration in FIG. 10, the dry powder fire extinguishing agent discharging through the discharge nozzle assembly 30 of the fire extinguisher 20 disclosed herein discharges as a dense, low velocity flow that curves downward over a relatively short distance, D, of 4 to 5 feet (1.22 to 1.52 meters) from the point of discharge and expands to rain down on the target in a cloud. In an embodiment suitable for extinguishing a cooking oil fire in a cooking vessel on a stove top, the cloud may have a cross span, d, typically in the range of about 12 inches (30.5 centimeters), This discharge pattern is uniquely suited for extinguishing and suppressing range top cooking oil fires. The operator can readily direct the gently curving, relatively short reach, relatively low velocity discharge of fire extinguishing agent unto the surface of the fire, such as flaming cooking oil in a skillet 70 on a burner 72 on a range top 74, with low impact upon the cooking oil. Thus, even in a relatively small kitchen, the extinguisher can be utilized at a closer distance from the fire than conventional extinguishers.

To confirm the unique effectives of the fire extinguisher equipped with the discharge nozzle assembly 30 as disclosed herein for fighting range top cooking oil fires, a series of twenty fire extinguishment performance tests were conducted. In all twenty tests, the cooking oil fires were extinguished on the first attempt. Pot fire tests were conducted with four inches of vegetable oil in a 10 inch diameter by 7 inch high stainless steel pot on a gas range and also with four inches of peanut oil in a 10 inch diameter by 7 inch high stainless steel pot on a gas range. Griddle fire tests were conducted with ¼-½ inch of vegetable on a two inch high griddle on a gas range and an electric range. Skillet fire tests were conducted with one inch of vegetable oil in a 13-14 inch diameter, 2 inch high cast iron skillet and also with one inch of peanut oil in a 13-14 inch diameter, 2 inch high cast iron skillet.

The tests were conducted with a handheld fire extinguisher 20 charged with dry powder sodium bicarbonate and dry air with 5% helium gas at a pressure of 100 psi and equipped with a discharge nozzle assembly 30 as disclosed herein. The discharge nozzle assembly included a horn 34 having an overall length of 1.0 inches and an exit opening diameter of 0.776 inches and a discharge nozzle having an overall length of 1.06 inches and a head 31 diameter of 0.5 inch. The width of the two dispersion slots 62, 64 was 0.090 inch and the outlets opening from the inlet passage to the respective dispersion slots had a diameter of 0.096 inch.

The discharge nozzle 32 has been described hereinbefore with reference to the exemplary embodiment having a pair of discharge passages including dispersion slots 62, 64 opening into the discharge chamber 52 and in fluid communication with the inlet passage 60 through the first and second outlets 66, 68 thereof. The dispersion slots produce circumferential spreading of the fire extinguishing agent passing into the discharge chamber to impact the wall of the horn through a substantially complete 360 degree arc, as opposed to impacting the wall of the horn as a pair of opposed discrete streams or a plurality of discrete streams. The number of dispersion slots and the arrangement thereof may be varied while still producing the desired circumferential spreading of the fire extinguishing agent discharged therethrough.

The terminology used herein is for the purpose of description, not limitation. Specific structural and functional details disclosed herein are not to be interpreted as limiting, but merely as basis for teaching one skilled in the art to employ the present invention. Those skilled in the art will also recognize the equivalents that may be substituted for elements described with reference to the exemplary embodiments disclosed herein without departing from the scope of the present invention.

While the present invention has been particularly shown and described with reference to the exemplary embodiments as illustrated in the drawing, it will be recognized by those skilled in the art that various modifications may be made without departing from the spirit and scope of the invention. For example, the discharge nozzle assembly is not limited to use on fire extinguishers charged with alkali metal bicarbonates, but may also be suited for use on fire extinguishers charged with other dry powder, chemical fire extinguishing agents. Therefore, it is intended that the present disclosure not be limited to the particular embodiment(s) disclosed as, but that the disclosure will include all embodiments falling within the scope of the appended claims.

We claim:

1. A portable, hand-held fire extinguisher comprising:
a vessel containing a dry powder fire extinguishing agent; and
a discharge nozzle assembly including a discharge nozzle and a horn, the horn circumscribing a distal end of the discharge nozzle and defining a discharge chamber having an open distal end, the discharge nozzle having a discharge passage in the distal end of the discharge nozzle, the discharge passage including a dispersion slot opening into the discharge chamber of the horn.

2. The fire extinguisher as recited in claim 1 wherein the dispersion slot is adapted to establish a flow of fire extinguishing agent in a fan-like distribution to impact an interior surface of the horn.

3. The fire extinguisher as recited in claim 2 further comprising a longitudinally elongated inlet passage in communication with the vessel for receiving a flow of dry powder fire extinguishing agent released from the vessel, the dispersion slot in flow communication with the inlet passage.

4. The fire extinguisher as recited in claim 3 further comprising:
a pair of discharge passages, each discharge passage including a dispersion slot opening into the discharge chamber of the horn;
a first outlet opening from the inlet passage into a first of the dispersions slots; and
a second outlet opening from the inlet passage into a second of the dispersion slots, the second outlet disposed so as to substantially counter balance discharge force produced by fire extinguishing agent passing through the first outlet

5. The fire extinguisher as recited in claim 4 wherein the first of the dispersion slots has a width less than a diameter of the first outlet and the second of the dispersion slots has a width less than a diameter of the second outlet.

6. The fire extinguisher as recited in claim 4 wherein each of the dispersion slots extends perpendicularly relative to the inlet passage.

7. The fire extinguisher as recited in claim 1 wherein the dry powder fire extinguishing agent comprises a dry chemical fire extinguishing agent effective for suppressing cooking oil fires.

8. The fire extinguisher as recited in claim 7 wherein the dry powder fire extinguishing agent comprises an alkali metal salt.

9. The fire extinguisher as recited in claim 8 wherein the dry powder fire extinguishing agent comprises sodium bicarbonate.

10. A discharge nozzle assembly for use in discharging a dry powder, comprising:
a discharge nozzle having a flow passage having a longitudinally elongated inlet passage for receiving a flow of dry powder at a proximal end of the discharge nozzle and at least a pair of dispersion slots in a distal end of the discharge nozzle extending transversely to the inlet passage, each dispersion slot defining a discharge passage; and
a horn circumscribing at least the distal end of the discharge nozzle having the dispersion slots and defining a discharge chamber having an open distal end, each dispersion slot opening into the discharge chamber of the horn.

11. The discharge nozzle assembly as recited in claim 10 further comprising a first outlet opening from the inlet passage into a first of the dispersions slots and a second outlet opening from the inlet passage into a second of the dispersion slots.

12. The discharge nozzle assembly as recited in claim 11 wherein the first of the dispersion slots has a width less than a diameter of the first outlet and the second of the dispersion slots has a width less than a diameter of the second outlet.

13. The discharge nozzle assembly as recited in claim 10 wherein each of the dispersion slots is adapted to establish a flow of fire extinguishing agent passing therethrough in a fan-like distribution to impact an interior surface of the horn.

14. The discharge nozzle assembly as recited in claim 11 wherein the first outlet opening and the second outlet opening are disposed so as to counter-balance discharge reaction forces.

15. The discharge nozzle assembly as recited in claim 14 wherein each of the dispersion slots extends perpendicularly relative to the inlet passage.

16. A discharge nozzle comprising:
an elongated body having a head and a shaft extending from the head along a longitudinal axis, the body further including an elongated inlet section extending along the longitudinal axis and a pair of discharge passages in the head extending transversely to the inlet passage, each discharge passage including a dispersion slot in flow communication with the inlet passage.

17. The discharge nozzle as recited in claim 16 further comprising a first outlet opening from the inlet passage into a first of the dispersions slots and a second outlet opening from the inlet passage into a second of the dispersion slots.

18. The discharge nozzle as recited in claim 17 wherein the first of the dispersion slots has a width less than a diameter of the first outlet and the second of the dispersion slots has a width less than a diameter of the second outlet.

19. The discharge nozzle as recited in claim 16 wherein each of the dispersion slots of the pair of dispersion slots defines a discharge passage through which fire extinguishing agent passing therethrough discharges in a fan-like distribution to impact an interior surface of the horn.
